(19) United States
(12) Patent Application Publication
(10) Pub. No.: US 2011/0210960 A1
(43) Pub. Date: Sep. 1, 2011

(54) Hierarchical blurring of texture maps

(75) Inventors: Costa Touma, Haifa (IL); Emil C. Praun, Mountain View, CA (US)

(73) Assignee: Google Inc., Mountain View, CA (US)

(21) Appl. No.: 12/659,177

(22) Filed: Feb. 26, 2010

(51) Int. Cl. G06T 15/00; G09G 5/00

(52) U.S. Cl. 345/419; 345/582

(57) ABSTRACT

Systems and methods for hierarchical blurring of texture maps are described herein. An embodiment includes determining a region where a texture is partially mapped to a 3D surface and populating an unmapped portion of the determined region with compressible low frequency data. A system embodiment includes a region determiner to determine a region of interest in an image and a blurring engine to populate an unmapped portion of determined region with compressible low frequency data. In this way, when a texture is partially mapped to the 3D model's surface, leaving the rest unused, embodiments of the invention save bandwidth by padding an unmapped region with compressible low frequency information. Furthermore, embodiments avoid contaminating a rendered 3D model with unwanted colors which bleed in when unmapped pixels are averaged in with mapped pixels.

### BACKGROUND

1. Field

Embodiments of the present invention relate to computer graphics and more particularly to texture maps.

2. Background Art

Texture mapping is a method for adding detail, surface texture, or color to a computer-generated graphic or three dimensional (3D) model. A texture is often partially mapped to a 3D model's surface, leaving a portion of the texture unused. This can cause a waste of bandwidth when 3D model data is streamed over a network. Furthermore, unwanted color bleeding occurs when unmapped pixels in a texture map are averaged in with mapped pixels to produce MIP maps or texture atlases. Color bleeding contaminates a rendered 3D model with unwanted colors which bleed into the rendered 3D model. Furthermore, present rendering methods suffer from a variety of unwanted artifacts caused due to pixels that are stored in a texture map, but remain unmapped during the rendering of a 3D model.

### BRIEF SUMMARY

Embodiments of the present invention relate to hierarchical blurring of texture maps. An embodiment includes determining a region where a texture is partially mapped to a three dimensional (3D) surface and populating an unmapped portion of the determined region with compressible low frequency information, in a hierarchical manner, for each resolution of the texture. A system embodiment includes a region determiner to determine a region of interest in an image and a blurring engine to populate an unmapped portion of the determined region with compressible low frequency information.

In this way, when a texture is partially mapped to the 3D model's surface, leaving the rest of the texture unused, embodiments of the invention reduce bandwidth needed to transmit the 3D model by replacing an unmapped region of the texture with compressible low frequency information. Furthermore, embodiments avoid contaminating a rendered 3D model with unwanted colors which may bleed in when unmapped texture pixels are averaged in with mapped texture pixels.

Further embodiments, features, and advantages of the invention, as well as the structure and operation of the various embodiments of the invention are described in detail below with reference to accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1A illustrates a system for hierarchical blurring of texture maps, according to an embodiment.

FIG. 1B illustrates a system for hierarchical blurring of texture maps, according to another embodiment.

FIG. 2 illustrates a blurring engine, according to an embodiment.

FIG. 3 illustrates an exemplary input texture in color, according to an embodiment.

FIG. 4A is a diagram that illustrates an exemplary texture minification operation, according to an embodiment.

FIG. 4B is a flowchart that illustrates a texture minification operation, according to an embodiment.

FIG. 5A is a flowchart that illustrates a pixel mapping and blurring operation, according to an embodiment.

FIG. 5B illustrates an exemplary blurring operation, according to an embodiment.

FIG. 5C is a flowchart illustrating an exemplary pixel mapping and blurring operation, according to an embodiment.

FIG. 6 illustrates an exemplary output texture in color, according to an embodiment.

FIG. 7 illustrates an example computer useful for implementing components of the embodiments.

### DETAILED DESCRIPTION

Embodiments of the present invention relate to hierarchical blurring of texture maps. An embodiment includes determining a region where a texture is partially mapped to a three dimensional (3D) surface and populating an unmapped portion of the determined region with compressible low frequency information, in a hierarchical manner, for each resolution of the texture. When an unmapped portion of the texture is populated with an compressible low frequency information, such as an average color value determined from the mapped pixels of the texture, abrupt color transitions in colors that may occur in the texture are minimized. Because abrupt color transitions are minimized, high frequency content occurring in the texture is also minimized. This allows the texture to be efficiently and effectively compressed by image compression techniques (e.g. wavelet based compression techniques).

In this way, when a texture is partially mapped to the 3D model's surface, leaving the rest of the texture unused, embodiments of the invention reduce bandwidth needed to transmit the 3D model by replacing an unmapped region of the texture with compressible low frequency information. Furthermore, embodiments avoid contaminating a rendered 3D model with unwanted colors which may bleed in when unmapped texture pixels are averaged in with mapped texture pixels.

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

This detailed description of the embodiments of the present invention is divided into several sections as shown by the following table of contents.

### Table of Contents

### 1. System

### 2. Hierarchical Blurring of Texture Maps

### 3. Texture Minification

### 4. Pixel Mapping and Blurring

### 5. Exemplary Overall Algorithm

### 6. Example Computer Embodiment

### 1. System

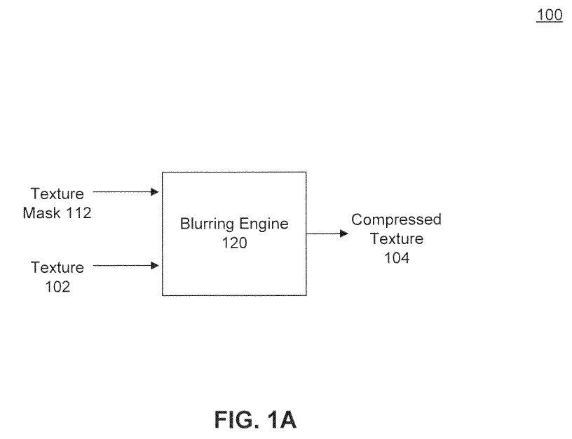

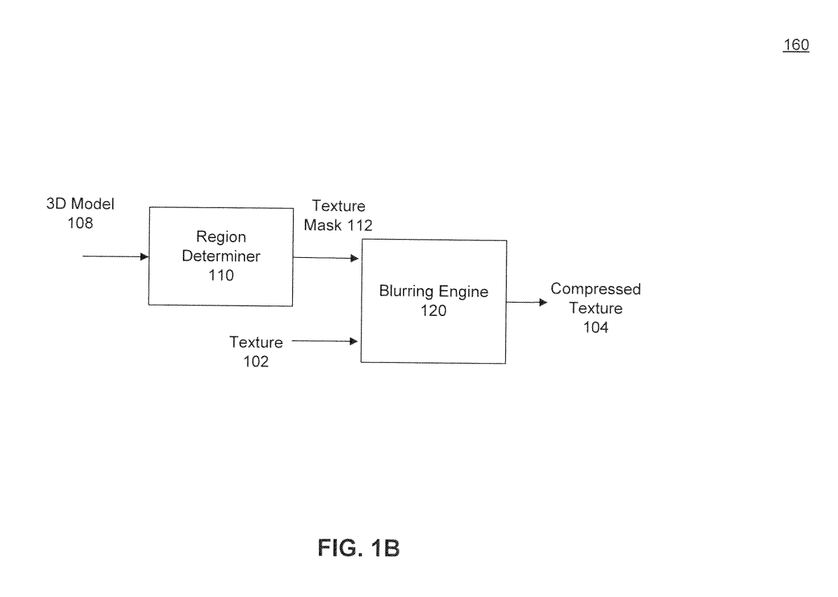

This section describes systems for hierarchical blurring of texture maps, according to embodiments of the invention. FIG. 1A is a diagram of system 100 for hierarchical blurring of texture maps, according to an embodiment. FIG. 1B is a diagram of system 160 for hierarchical blurring of texture maps, according to another embodiment While the following is described in terms of texture maps, the invention is not limited to this embodiment. Embodiments of the invention can be used in conjunction with any texture or image manipulation technique(s). For example, embodiments of the invention can be used in any system having generally the structure of FIG. 1A or FIG. 1B, or that would benefit from the operation, methods and functions as described herein.

System 100 includes blurring engine 120. In an embodiment, not intended to limit the invention, texture 102 and texture mask 112 are provided as inputs to blurring engine 120 and compressed texture 104 is obtained as an output of system 100. Texture mask 112 may store for each pixel in texture 102 whether the pixel is mapped or unmapped to a 3D surface. In another embodiment, shown in FIG. 1B, system 160 includes a region determiner 110 that receives a textured 3D model 108 as an input and computes texture mask 112 that is provided to blurring engine 120 along with texture 102. Thus, region determiner 110 may be used to determine a texture mask or a region where texture 102 is partially mapped to a 3D surface. The operation of region determiner 110 is described further in Section 2.

Texture 102 includes any image data that can be used as a texture (or texture map, texture atlas etc.). In an embodiment, not intended to limit the invention, texture 102 is a multi-resolution texture that includes plurality of resolution levels. As known to those skilled in the art, texture mapping is a method for adding detail, surface texture, or color to a computer-generated graphic or 3D model. A texture map may be applied (mapped) to the surface of a 3D shape or polygon. Texture mapping techniques may use pre-selected images that are mapped to a 3D model.

In some cases, textures (or images) are partially mapped to a 3D surface. As discussed above, partial mapping of textures to a 3D surface leaves a portion of a texture unused. Therefore, if the texture (e.g. texture 102) is transmitted or streamed over a network, a waste of bandwidth occurs due to any unused texture. Furthermore, unwanted color bleeding occurs when unmapped pixels in a texture map are averaged in with mapped pixels to produce multi-resolution maps (such as, MIP maps) or texture atlases.

In an embodiment, blurring engine 120 populates an unmapped portion of a texture region determined by region determiner 110 with compressible low frequency information. Compressible low frequency data may provide a high compression factor and may require lesser bandwidth compared to an image based texture. Thus, use of compressible low frequency data may allow a saving of bandwidth when the texture 102 is streamed over a network.

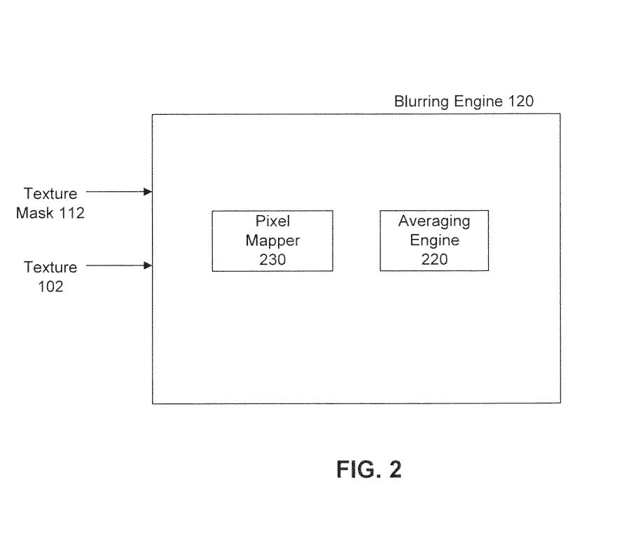

FIG. 2 is a diagram of blurring engine 120 in greater detail, according to an embodiment. As shown in FIG. 2 blurring engine 120 includes averaging engine 220 and pixel mapper 230. As an example, texture mask 112 indicates mapped and unmapped pixels of texture 102. Averaging engine 220 averages colors of a plurality of mapped pixels of texture 102 and a pixel mapper 230 maps one or more unmapped pixels of the texture 102 to low frequency compressible information or an average color value. The operation of blurring engine 120, averaging engine 220 and pixel mapper 230 is described further below in Section 2.

Region determiner 110 and blurring engine 120 may be implemented on any computing device that can support graphics processing and rendering. Such a computing device can include, but is not limited to, a personal computer, mobile device such as a mobile phone, workstation, embedded system, game console, television, set-top box, or any other computing device that can support computer graphics and image processing. Such a device may include, but is not limited to, a device having one or more processors and memory for executing and storing instructions. Such a computing device may include software, firmware, and hardware. Software may include one or more applications and an operating system. Hardware can include, but is not limited to, a processor, memory and a display.

### 2. Hierarchical Blurring of Texture Maps

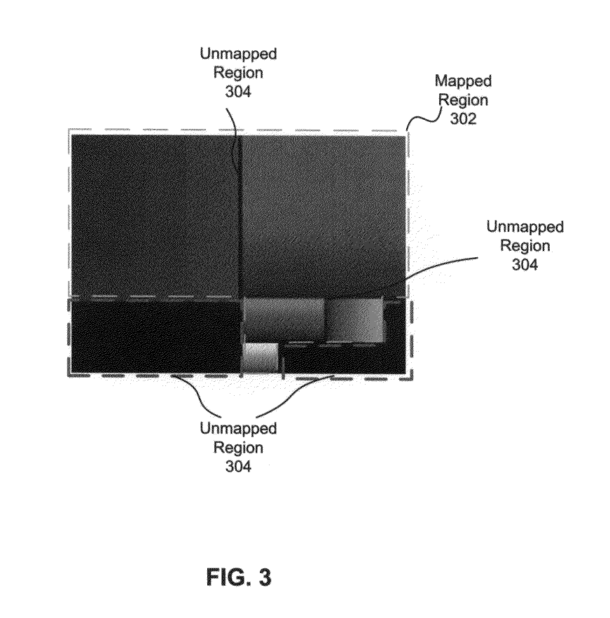

FIG. 3 illustrates exemplary texture 102, according to an embodiment of the invention. As shown in FIG. 3, texture 102 comprises mapped region 302 and unmapped region 304. In exemplary texture 102, mapped region 302 appears colored (e.g. blue, magenta, red, green and yellow). Unmapped region 304 lacks color and appears black. It is to be noted that unmapped region 304 includes all unmapped regions including thin black regions (or lines) that appear to separate two or more mapped or colored regions. As discussed earlier, if texture 102 is transmitted or streamed over a network with unmapped pixels, a waste of bandwidth occurs due to these unused texture pixels. Furthermore, texture 102 comprises colored and uncolored regions resulting in a high frequency of change in texture image data. Present compression techniques (e.g. wavelet based compression techniques) are unable to efficiently compress image data that exhibits a high frequency of change or includes high frequency image content. Furthermore, existing compression techniques such as JPEG 2000 may have an adverse effect of considerable increasing texture image dimensions after compression is achieved. Thus, it is necessary to convert texture 102 into a form that is highly compressible by wavelet-based image compression techniques. In an embodiment, not intended to limit the invention, this can be achieved by populating the unmapped portion of texture 102 with highly compressible low frequency information.

In an embodiment, region determiner 110 determines unmapped region 304 and mapped region 302. As an example, region determiner 110 may check for each pixel in texture 102 if the pixel is mapped to a 3D surface. As a purely illustrative example, not intended to limit the invention, such a checking operation may include checking texture co-ordinates of texture 102. If, for example, it is determined that the pixel is mapped to a 3D surface then the pixel belongs to mapped region 302. If, for example, it is determined that the pixel is not mapped to a 3D surface then the pixel belongs to unmapped region 304.

To accomplish populating an unmapped portion of the region determined by region determiner 110 with compressible low frequency information, texture mask 112 associated with texture 102 is used by blurring engine 120. As discussed above, texture mask 112 may be provided directly to blurring engine 120 as shown in FIG. 1A or can be generated by region determiner 110 and then provided to blurring engine 120 as shown in FIG. 1B. Texture mask 112 may store for each pixel in texture 102 whether the pixel is mapped or unmapped to a 3D surface. In this way, texture mask 112 effectively distinguishes a mapped portion of texture map 102 from an unmapped portion of texture map 102. Furthermore, texture mask 112 allows embodiments of the invention to maintain a higher resolution of the mapped portion of texture 102 while applying pixel mapping and blurring operations to the unmapped portion of texture 102.

### 3. Texture Minification

In an embodiment, to populate an unmapped portion of texture 102 determined by region determiner 110 with compressible low frequency information, blurring engine 120 performs a texture minification operation in which unmapped pixels of texture 102 are populated with an average color value. Blurring engine 120 performs the texture minification operation recursively over each resolution level (or hierarchy) of texture 102. In an embodiment, texture minification of texture 102 is performed by averaging engine 220 and pixel mapper 230 in blurring engine 120.

In an embodiment, averaging engine 220 averages mapped pixels of texture 120 into one average color value using texture mask 112 as a weight. Pixel mapper 230 then populates unmapped pixels of texture 102 with the average color value. When unmapped pixels of texture 102 are populated with an average color value, abrupt color transitions in colors that may occur in texture 102 are minimized. Because abrupt color transitions are minimized, high frequency content occurring in texture 102 is also minimized allowing texture 102 to be efficiently and effectively compressed by image compression techniques (e.g. wavelet based compression techniques).

As stated above, in an embodiment, texture minification accomplished by embodiments of the invention is recursive and a average color value is calculated at each texture resolution level (or hierarchy) using mapped pixels of texture 102. This calculated average color value is then used to populate the unmapped pixels at a next resolution level (e.g. a lower resolution level). In an embodiment, a recursive texture minification operation begins at the lowest level (highest texture resolution) of texture 102 and progresses to the highest level (lowest texture resolution) of texture 102. At each resolution level of texture 102, at least two operations are performed, namely, the calculation of an average color value and the calculation of an average texture mask value. The average color value is used to populate the unmapped pixels of texture 102 at its next lower resolution level. In a similar manner, the average mask value is used to populate texture mask 112 at its next lower resolution level to match the corresponding resolution of texture 102.

The above operations performed by blurring engine 120 effectively minify the texture 102 because, at each resolution level of texture 102, a plurality of pixels are averaged into one pixel and this process continues recursively till one (or more) pixels represent(s) an average color value for all mapped pixels of texture 102.

For example, consider that each pixel in texture 102 has color cᵢ. Also, consider that each mask value in texture mask 112 is mᵢ.

In an embodiment, an average color value ‘cₐᵥ’ is determined by averaging engine 220 as:

cₐᵥ=Σ(cᵢ*mᵢ, for i=0 . . . n)/Σ(mᵢ, for i=0 . . . n) (1)

where,

‘n’ represents a dimension of texture 102. For example, if texture 102 is 2×2 texture having 4 pixels, n would equal 3.

‘cᵢ’ represents a color of the i^{th} pixel in texture 102,

‘mᵢ’ represents a value of the i^{th} value in texture mask 112.

Therefore, in the above exemplary equation, the average color value cₐᵥ is computed by averaging engine 220 as a weighted average of all pixels present at a given resolution of texture 102. In equation (1), each color value cᵢ is weighted by texture mask value mᵢ so that only mapped pixels of texture 102 are used to calculate cₐᵥ. The computed average color value (cₐᵥ) is used to populate the unmapped pixels of the texture 102 at the next lower resolution level and the process continues for each resolution level of texture 102.

In an embodiment, the average mask value (mₐᵥ) is used to populate texture mask 112 at its next lower resolution level to match the corresponding resolution of texture 102.

In an embodiment, the average texture mask value (mₐᵥ) is determined by averaging engine 220 as:

mₐᵥ=Σ(mᵢ, for i=0 . . . n)/Count(mᵢ, i=0 . . . n) (2)

where,

‘n’ represents a dimension of texture mask 112. For example, if texture mask 112 is a 2×2 mask that includes 4 pixels, n would equal 3. In an embodiment, texture mask 112 may match the dimensions of texture 102.

‘mᵢ’ represents a value of the i^{th} value in texture mask 112. As a purely illustrative example, not intended to limit the invention, texture mask values may include real values between 0 to 1 or integer values between 0 to 255.

In this way, computation of an average color value effectively averages ‘n’ pixels of texture 102 into one average color pixel for the next lower resolution of texture 102. Thus, for example, if a texture resolution level comprises n pixels, where n is a power of 2, then the next lower texture resolution level would comprise n/4 pixels. Also, texture mask 112 needs to be minified to match the lower texture resolution and hence a average mask value is calculated to populate the mask values of a next lower resolution level of texture mask 112.

The above operations performed by blurring engine 120 effectively minify texture 102 because at each texture resolution level a plurality of pixels are averaged to one average color pixel. Thus, in an embodiment, averaging engine 220 returns a color pixel that represents an average color value of all mapped pixels of texture 102.

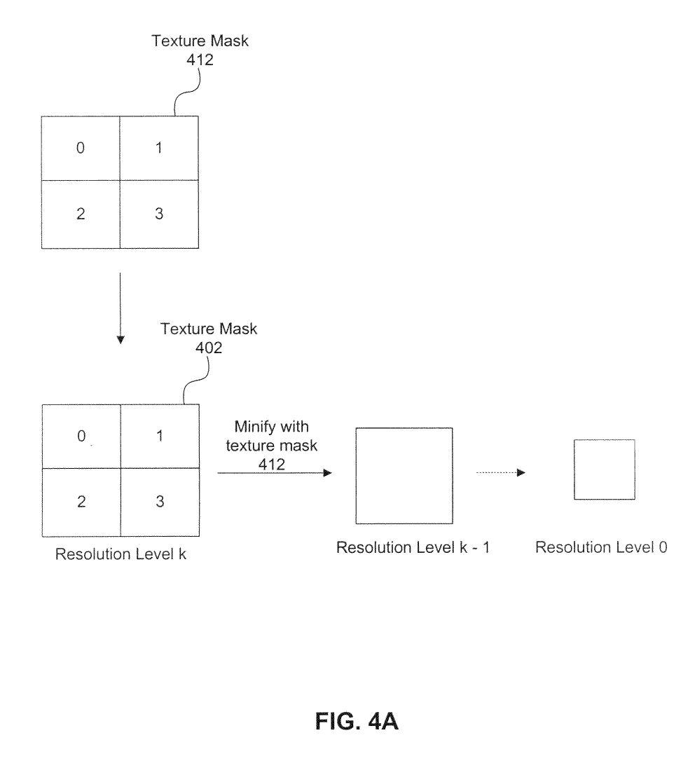

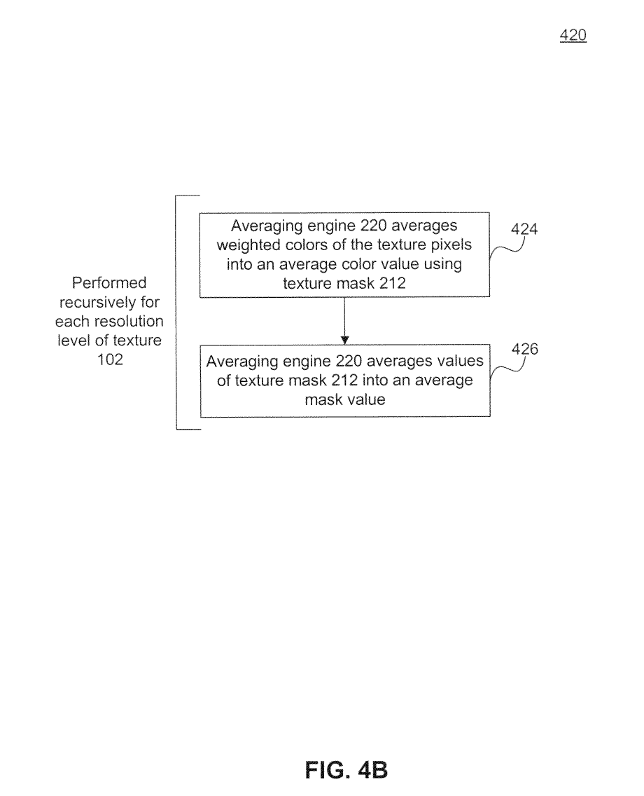

An exemplary texture minification operation is described further below with respect to FIG. 4A.

FIG. 4A illustrates a texture 402 that includes four pixels, namely pixel 0, 1, 2 and 3. Texture 402 is associated with texture mask 412. As an example, texture mask 412 may be generated by region determiner 110. Texture mask 412 includes 4 values and matches the resolution of texture 402. The above described texture minification operation is performed at each resolution level of texture 402, according to embodiments of the invention. Thus, using equation (1), an average color value (cₐᵥ) for exemplary texture 402 may be computed as,

cₐᵥ=Σ(cᵢ*mᵢ, for i=0.3)/Σ(mᵢ, for i=0 . . . 3)

where,

‘3’ represents a dimension of texture 402, because texture 402 is represented using 4 pixels (i.e. 0 to 3 pixels).

‘cᵢ’ represents a color of the i^{th} pixel in texture 402,

‘mᵢ’ represents a value of the i^{th} value in the texture mask 412.

The computed average color value (cₐᵥ) is used to populate the unmapped pixels of the texture 102 at the next lower resolution level and the process continues for each resolution level of texture 102. For example, referring to FIG. 4A, the texture minification operation may begin at resolution level k and progress to resolution level 0.

In an embodiment, the average mask value (mₐᵥ) is used to populate texture mask 412 at its next lower resolution level to match the corresponding resolution of texture 402. As discussed above, equation (2) can be used to compute an average mask value ‘m’ of texture mask 412. Thus, an average mask value ‘mₐᵥ’ is determined as:

mₐᵥ=Σ(mᵢ, for i=0 . . . 3)/Count(mᵢ, i=0 . . . 3)

where,

‘3’ represents the size of the texture mask 412 and is chosen because texture 402 is represented using 4 pixels (0 to 3 pixels) and texture mask 412 matches the dimensions of texture 402.

‘mᵢ’ represents a value of the i^{th} value in texture mask 412.

As shown in FIG. 4A and according to an embodiment, the above discussed steps of computation of an average color value and an average mask value are performed for each resolution level beginning from a highest resolution level (e.g. resolution level k) of texture 402 and progress to a lowest resolution level (e.g. resolution level k) of texture 402.

FIG. 4B illustrates method 420 for a recursive texture minification operation, according to an embodiment.

Method 420 begins with averaging engine 220 averaging weighted colors of the texture pixels into an average color value using texture mask 112 determined in step 422 (step 424). As an example, texture mask 112 can be generated based on determining if pixels in texture 102 are mapped or unmapped to a 3D surface. Thus, for example, texture mask 112 stores a mapping of each pixel in texture 102.

Averaging engine 220 also averages all values of texture mask 112 into an average mask value (step 426).

In an embodiment, not intended to limit the invention, steps 422 though 426 are performed recursively at each resolution level of texture 102. For example, steps 420 through 424 may be performed beginning at the highest resolution level of texture 102 and progress till a lowest resolution level or an average color value is obtained.

### 4. Pixel Mapping and Blurring

In an embodiment, pixel mapper 230 performs pixel mapping and replaces the unmapped pixels of texture 102 with pixels of an average color value returned from the texture minification operation. In an embodiment, pixel mapper 230 performs the process of pixel mapping, recursively, at each resolution level of texture 102. For example, a pixel mapping operation may begin at the lowest resolution level and progress towards the highest resolution of texture 102. Thus, if an average color value is represented by one pixel at the lowest resolution of texture 102, it is magnified to n (e.g. 4) pixels at the next highest resolution level in the unmapped portion of texture 102. In this way, the average color value (cₐᵥ) computed during texture minification is populated recursively to unmapped pixels of texture 102.

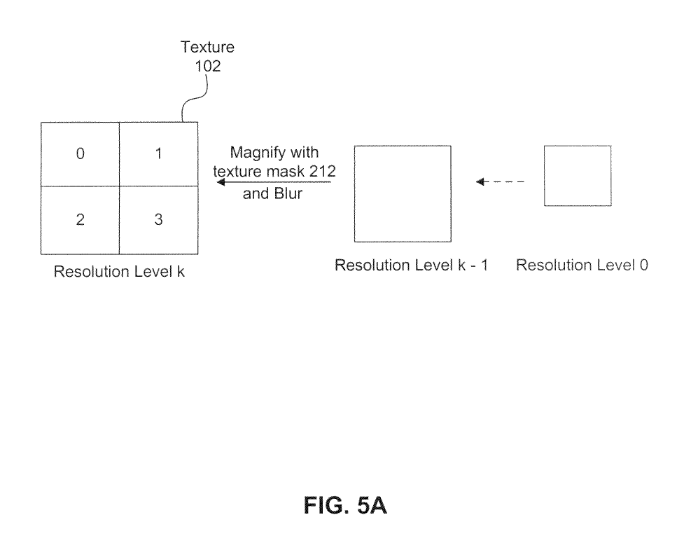

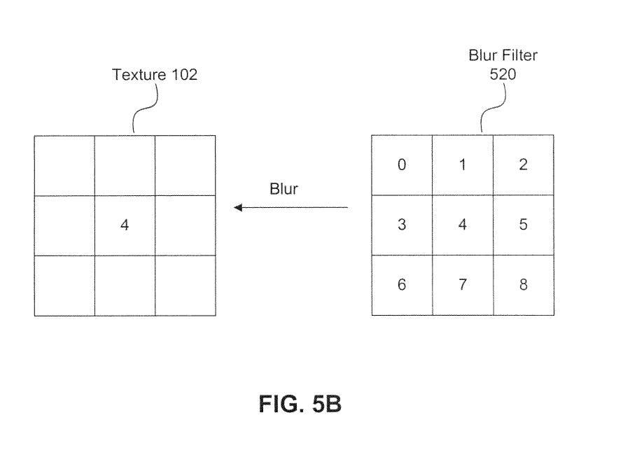

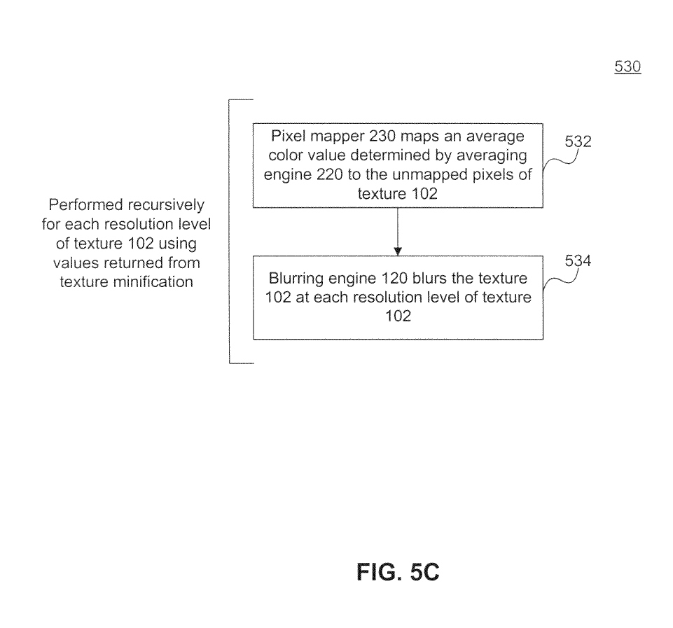

FIG. 5A illustrates an exemplary pixel mapping operation performed by pixel mapper 230, according to an embodiment of the invention. As illustrated in FIG. 5A, each pixel (cᵢ) in unmapped pixels of texture 102 is replaced with average color value computed by averaging engine 220. Furthermore, the pixel mapping operation is performed recursively from resolution level 0 (lowest texture resolution) and progresses towards resolution level k (highest texture resolution), as indicated by arrows in FIG. 5A.

Furthermore, at each resolution level of texture 102, a low pass filtering or blurring operation is performed. Such a low-pass filtering operation may be accomplished by using a kernel filter. A kernel filter works by applying a kernel matrix to every pixel in texture 102. The kernel contains multiplication factors to be applied to the pixel and its neighbors. Once all the values have been multiplied, the pixel is replaced with the sum of the products. By choosing different kernels, different types of filtering can be applied. As a purely illustrative example, a Gaussian filter may be implemented as a kernel filter. In an embodiment, blurring engine 220 runs a low pass filter over texture 102 once the unmapped pixels have been replaced by with an average color value by pixel mapper 230.

FIG. 5B illustrates an exemplary 3×3 blur filter 520 that performs a weighted average blurring operation over all unmapped pixels of texture 102. For example, as illustrated in FIG. 5B, the color value of pixel C₄ can be computed by blurring engine 220 using blur filter 520 as:

C₄=Σ(cᵢ*bᵢ, for i=0 . . . 8)/Σ(bᵢ, for i=0 . . . 8)

where,

‘8’ represents the size of blur filter 520. A value of ‘8’ is chosen because blur filter 520 is a 3×3 filter that comprises 9 pixels (0 to 8 pixels).

‘cᵢ’ represents a color of the i^{th} pixel in texture 102,

‘bᵢ’ represents a value of the i^{th} bit in blur filter 520.

In an embodiment, blur filter 520 needs to be minified to match a lower texture resolution of texture 102 and hence a average blur filter value is calculated to populate bits of a next lower resolution level of blur filter 520.

In an embodiment, an average blur filter value ‘bₐᵥ’ is determined as:

bₐᵥ=Σ(bᵢ, for i=0 . . . 8)/Count(bᵢ, i=0 . . . 8)

where,

‘8’ represents the size of blur filter 520. As stated earlier, a value of ‘8’ is chosen because blur filter 520 is a 3×3 filter that comprises 9 pixels (0 to 8 pixels).

‘bᵢ’ represents a value of the i^{th} bit in blur filter 520.

FIG. 5C illustrates an exemplary method for pixel mapping and blurring, according to an embodiment. In an embodiment, the pixel mapping and blurring operations use relevant texture mask and color values returned from the texture minification operation illustrated in FIG. 4B.

Method 530 begins with pixel mapper 230, mapping an average color value determined by averaging engine 220 to the unmapped pixels of texture 102 (step 532). As an example, pixel mapper 230 replaces any black colored (or unmapped) pixels with pixels having an average color value determined by averaging engine 220. In an embodiment, step 532 is performed recursively at each resolution level of texture 102.

Blurring engine 120 also blurs the texture 102 at each resolution level (step 534). As described above, such a blurring operation may be performed using a kernel based low-pass filter.

In an embodiment, not intended to limit the invention, steps 532 though 534 are performed recursively at each resolution level of texture 102. For example, steps 532 through 534 may be performed beginning at the lowest resolution level of texture 102 (i.e. an average color value computed by averaging engine 220) and progress till a highest resolution level or compressed texture 104 is obtained.

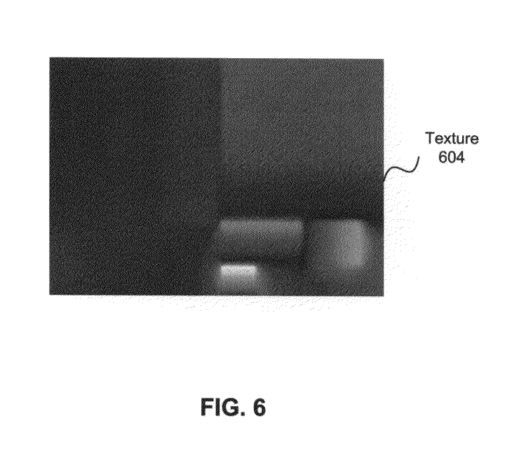

FIG. 6 illustrates an exemplary compressed texture 604 that is produced as an output by blurring engine 120, according to an embodiment. As shown in FIG. 6, the unmapped portion of texture 102 (region 304) has been replaced with compressible low frequency information. Particularly, region 304 of texture 102 has been replaced in texture 604 with an average color value generated by recursive texture minification. As is apparent from FIG. 6, abrupt color transitions in texture 604 are minimized. Thus, high frequency content occurring in the texture 604 is also minimized allowing texture 604 to be efficiently and effectively compressed by image compression techniques (e.g. wavelet based compression techniques). Furthermore, because the texture is effectively compressed, lesser bandwidth is required to transmit texture 604 over a network.

### 5. Exemplary Overall Algorithm

This section describes an exemplary overall algorithm for hierarchical blurring of texture maps, according to an embodiment. It is to be appreciated that the algorithm shown below is purely illustrative and is not intended to limit the invention.

procedure Blur(MaskedImage &image) {

if (image.width( ) <= 1 ∥ image.height( ) <= 1)
return;
MaskedImage minified_image = image.Minify( );
Blur(minified_image);
image.CopyUnmappedPixelsFrom(minified_image);
minified_image.LowPassFilterUnmappedPixels( );

}

Referring to the above exemplary algorithm, ‘MaskedImage’ may store texture 102's color channels (or pixel values) as well as a texture mask (e.g. texture mask 112).

A ‘Minify’ operation may average the weighted colors of texture 102's pixels into one average color using the texture mask as a weight. The ‘Minify’ operation also averages the texture mask values into a single average value, as discussed earlier. The condition ‘if (image.width( )<=1∥image.height( )<=1)’ may check, for example, if a lowest resolution level of texture 102 has been reached during the ‘Minify’ operation.

A ‘CopyUnmappedPixelsFrom’ operation overrides the colors of the unmapped pixels of texture 102 with their blurred value from the minified image returned by the recursive ‘Minify’ operation. As an example, the ‘CopyUnmappedPixelsFrom’ operation has the effect of magnifying the unmapped pixels (e.g. magnifying the unmapped pixels into a 2×2 grid), while retaining a finer masked resolution of the mapped pixels of texture 102.

A ‘LowpassFilterUnmappedPixels’ operation applies a low pass filter over the unmapped pixels of texture 102. This operation is similar to the blurring operation described above with respect to blur filter 520.

In this way, in the above exemplary algorithm, the blurring and pixel mapping operations have been interleaved while relying on the relevant texture mask and color values returned from the texture minify operation. In an embodiment, the blurring operation affects the color of the unmapped pixels of texture 102, and uses an average color value from the mapped pixels when blurring unmapped pixels adjacent to the mapped pixels at a given resolution level. Furthermore, the blurring and pixel mapping operations are performed recursively for each resolution of texture 102.

Embodiments of the present invention can be used in compressing textures applied to 3D objects, such as, buildings in the GOOGLE EARTH service available from GOOGLE Inc. of Mountain View, Calif., or other geographic information systems or services using textures. For example, 3D models (e.g. buildings) can have texture maps (e.g. texture 102) associated with them. Such textures may be partially mapped to the 3D models. As discussed above, partial mapping of textures to a 3D surface leaves a portion of the texture unused. However, embodiments of the invention replace unmapped portion of the texture with an average color value generated by recursive texture minification. When unmapped pixels of the texture are populated with an average color value, abrupt color transitions in colors that may occur in the texture are minimized. Because abrupt color transitions are minimized, high frequency content occurring in the texture is also minimized allowing the texture to be efficiently and effectively compressed by image compression techniques (e.g. wavelet based compression techniques). Furthermore, because the texture is effectively compressed, lesser bandwidth is required to transmit the texture over a network.

### 6. Example Computer Embodiment

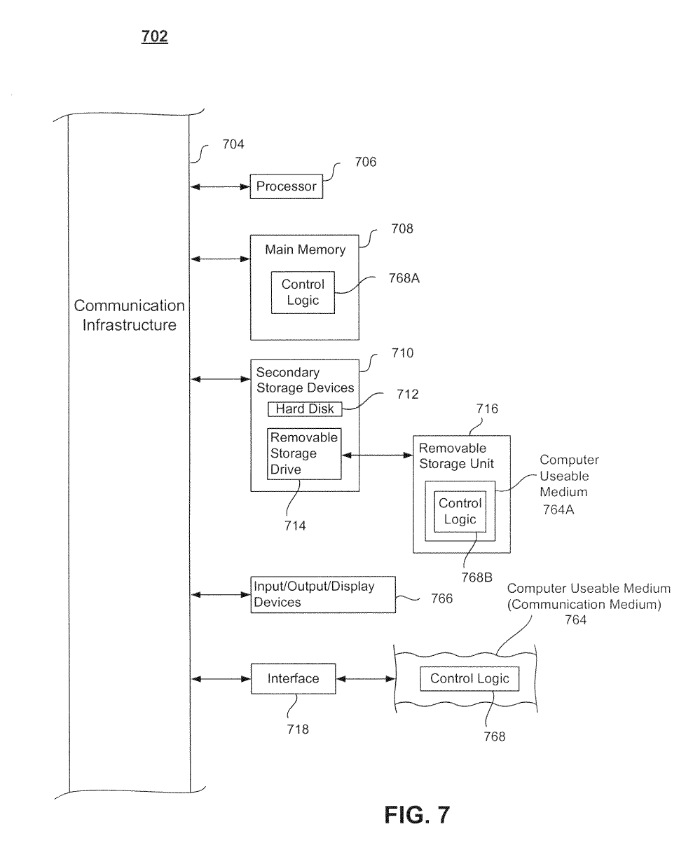

In an embodiment of the present invention, the system and components of embodiments described herein are implemented using well known computers, such as example computer 702 shown in FIG. 7. For example, region determiner 110 or blurring engine 120 can be implemented using computer(s) 702.

The computer 702 can be any commercially available and well known computer capable of performing the functions described herein, such as computers available from International Business Machines, Apple, Sun, HP, Dell, Compaq, Cray, etc.

The computer 702 includes one or more processors (also called central processing units, or CPUs), such as a processor 706. The processor 706 is connected to a communication infrastructure 704.

The computer 702 also includes a main or primary memory 708, such as random access memory (RAM). The primary memory 708 has stored therein control logic 727A (computer software), and data.

The computer 702 also includes one or more secondary storage devices 710. The secondary storage devices 710 include, for example, a hard disk drive 712 and/or a removable storage device or drive 714, as well as other types of storage devices, such as memory cards and memory sticks. The removable storage drive 714 represents a floppy disk drive, a magnetic tape drive, a compact disk drive, an optical storage device, tape backup, etc.

The removable storage drive 714 interacts with a removable storage unit 716. The removable storage unit 716 includes a computer useable or readable storage medium 724 having stored therein computer software 728B (control logic) and/or data. Removable storage unit 716 represents a floppy disk, magnetic tape, compact disk, DVD, optical storage disk, or any other computer data storage device. The removable storage drive 714 reads from and/or writes to the removable storage unit 716 in a well known manner.

The computer 702 also includes input/output/display devices 722, such as monitors, keyboards, pointing devices, etc.

The computer 702 further includes a communication or network interface 718. The network interface 718 enables the computer 702 to communicate with remote devices. For example, the network interface 718 allows the computer 702 to communicate over communication networks or mediums 724B (representing a form of a computer useable or readable medium), such as LANs, WANs, the Internet, etc. The network interface 718 may interface with remote sites or networks via wired or wireless connections.

Control logic 728C may be transmitted to and from the computer 702 via the communication medium 724B. More particularly, the computer 702 may receive and transmit carrier waves (electromagnetic signals) modulated with control logic 730 via the communication medium 724B.

Any tangible apparatus or article of manufacture comprising a computer useable or readable medium having control logic (software) stored therein is referred to herein as a computer program product or program storage device. This includes, but is not limited to, the computer 702, the main memory 708, secondary storage devices 710, the removable storage unit 716 but not the carrier waves modulated with control logic 730. Such computer program products, having control logic stored therein that, when executed by one or more data processing devices, cause such data processing devices to operate as described herein, represent embodiments of the invention.

Embodiments of the invention can work with software, hardware, and/or operating system implementations other than those described herein. Any software, hardware, and operating system implementations suitable for performing the functions described herein can be used. Embodiments of the invention are applicable to both a client and to a server or a combination of both.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer implemented method for compression of textured three dimensional (3D) data, comprising:
determining, with a computing device, a region where a texture is partially mapped to a 3D surface; and
populating an unmapped portion of the determined region with compressible low frequency information.

2. The method of claim 1, further comprising:
determining a texture mask associated with the texture, wherein the texture mask represents a mapping of texture pixels on the 3D surface.

3. The method of claim 2, wherein the texture comprises a multi-resolution texture having multiple levels of detail at different resolutions, further comprising:
computing, at each resolution level of the texture, an average color value from texture pixels that are mapped to the 3D surface.

4. The method of claim 3, wherein the texture comprises a multi-resolution texture having multiple levels of detail at different resolutions, further comprising:
populating, at each resolution level of the texture, the unmapped portion of the texture with the average color value.

5. The method of claim 2, further comprising:
computing, at each resolution of the texture, an average mask value from the texture mask.

6. The method of claim 5, further comprising:
computing another texture mask, at each resolution level of the texture, from the computed average mask value.

7. A computer implemented method for compression of images, comprising:
determining, with a computing device, a region of interest in an image;
discarding image data stored outside the region of interest using a hierarchical blur at each resolution of the image; and
compressing the image.

8. The method of claim 7, further comprising:
transmitting the compressed image.

9. A computer implemented method for hierarchical blurring of textures, comprising:
generating, with a computing device, a texture mask associated with pixels of a texture;
averaging colors of the pixels into an average color value using the generated texture mask; and
populating one or more pixels of the texture, using the texture mask, with the average color value to reduce high frequency image content in the texture.

10. The method of claim 9, wherein the generating step comprises:
determining a mapping of texture pixels to a three dimensional (3D) surface.

11. The method of claim 9, further comprising:
filtering the pixels after the populating step.

12. A computer based system for compression of a texture, comprising:
a region determiner to determine a region where a texture is partially mapped to a 3D surface; and
a blurring engine to populate an unmapped portion of the determined region with compressible low frequency information.

13. The system of claim 12, wherein the blurring engine further comprises:
an averaging engine to average colors of a plurality of texture pixels; and
a pixel mapper to populate an unmapped portion of the determined region with the compressible low frequency information.

14. A computer program product having control logic stored therein, said control logic enabling one or more processors to perform compression of textured three dimensional (3D) data according to a method, the method comprising:
determining, with a computing device, a region where a texture is partially mapped to a 3D surface; and
populating an unmapped portion of the determined region with compressible low frequency information.

15. The computer program product of claim 14, the method further comprising:
determining a texture mask associated with the texture, wherein the texture mask represents a mapping of texture pixels the 3D surface.

16. The computer program product of claim 15, the method further comprising:
computing, at each resolution of the texture, an average color value from texture pixels that are mapped to the 3D surface.

17. The computer program product of claim 16, the method further comprising:
populating, at each resolution of the texture, the unmapped portion of the texture with the average color value.

18. The computer program product of claim 15, the method further comprising:
computing, at each resolution of the texture, an average mask value from the texture mask.

19. The computer program product of claim 18, the method further comprising:
computing another texture mask, at each resolution of the texture, from the computed average mask value.
